(19) United States
(12) Patent Application Publication
(10) Pub. No.: US 2021/0166556 A1
(43) Pub. Date: Jun. 3, 2021

(54) System for Providing Traffic Information and Method for the Same

(71) Applicants: Hyundai Motor Company, Seoul (KR); Kia Motors Corporation, Seoul (KR)

(72) Inventor: Sung Hwan Park, Seongnam-si (KR)

(21) Appl. No.: 16/879,189

(22) Filed: May 20, 2020

(30) Foreign Application Priority Data
Dec. 3, 2019 (KR) 10-2019-0159273

(51) Int. Cl. G08G 1/01

(52) U.S. Cl. CPC G08G 1/0116

(57) ABSTRACT

A system for providing traffic information includes a communication device configured to receive crossroad passing information and traffic light information from a probe vehicle, and a processor configured to select a correction reference based on the traffic light information, correct a traveling speed of the probe vehicle based on the correction reference, and provide the traffic information by reflecting the corrected traveling speed.

### CROSS-REFERENCE TO RELATED APPLICATIONS

This application claims priority to Korean Patent Application No. 10-2019-0159273, filed in the Korean Intellectual Property Office on Dec. 3, 2019, which application is hereby incorporated herein by reference.

### TECHNICAL FIELD

The present disclosure relates to a system for providing traffic information and a method for the same.

### BACKGROUND

In general, a traffic information service system collects traffic information in real time and guides present traffic information based on the collected traffic information, or predicts and guides the present traffic information by utilizing previous traffic information which is previously collected. Such a traffic information service system may collect the traffic information in real time by using a probe vehicle.

However, real-time traffic information is collected based on only the speed of the probe vehicle in a place having a smaller scale of probe data. In this case, distorted traffic information may be collected depending on the type of a traffic signal allowing the probe vehicle to pass. Accordingly, the traffic information may not be correctly provided.

### SUMMARY

Embodiments of the present disclosure have been made to solve problems occurring in the prior art while advantages achieved by the prior art are maintained intact.

An embodiment of the present disclosure provides a system for providing traffic information, capable of generating representative traffic information only through one probe vehicle by reflecting information on a traffic signal when generating the traffic information in real time, and a method for the same.

The technical problems to be solved by the present inventive concept are not limited to the aforementioned problems, and any other technical problems not mentioned herein will be clearly understood from the following description by those skilled in the art to which the present disclosure pertains.

According to an embodiment of the present disclosure, a system for providing traffic information includes a communication device configured to receive crossroad passing information and traffic light information from a probe vehicle, and a processor configured to select a correction reference based on the traffic light information, correct a traveling speed of the probe vehicle based on the correction reference, and provide the traffic information by reflecting the corrected traveling speed.

The crossroad passing information includes a time for the probe vehicle to pass through a crossroad.

The traffic light information includes a traffic light cycle, a signal state, and a time remaining until a signal is changed.

The processor selects, as the correction reference, a time point for the probe vehicle to reach a crossroad, which is matched to an average signal waiting time at the crossroad through which the probe vehicle passes.

The processor calculates a correction value for correcting a time for the probe vehicle to pass through the crossroad by utilizing the correction reference, the traffic light information, and the time for the probe vehicle to reach the crossroad.

The processor determines, as the correction value, the average signal waiting time at the crossroad, when a signal of a traffic light is a progress signal at a time point for the probe vehicle to enter the crossroad.

The processor calculates the correction value (C) through

$$C ( {J}_{i} > J ) = \frac{- T}{{J}_{max} - J} ( {J}_{i} - J ) + T$$

in which ‘T’ denotes the average signal waiting time, ‘J’ denotes the correction reference, ‘J₁’ denotes the time point for the probe vehicle to enter the crossroad, Jₘₐₓ denotes a time point for the probe vehicle to reach the crossroad, which is matched to a minimum signal waiting time within a traffic light cycle, when the signal of the traffic light is not the progress signal at the time point for the probe vehicle to enter the crossroad, and the probe vehicle enters the crossroad later than the correction reference.

The processor calculates the correction value (C) through

$$C ( {J}_{i} < J ) = \frac{{T}_{max} - T}{J - {J}_{min}} ( {J}_{i} - {J}_{min} ) + ( T - {T}_{max} ) ,$$

in which ‘T’ denotes the average signal waiting time, ‘Tₘₐₓ’ denotes a maximum waiting time, ‘J’ denotes the correction reference, ‘J₁’ denotes the time point for the probe vehicle to enter the crossroad, ‘Jₘᵢₙ’ denotes the time point for the probe vehicle to reach the crossroad, which is matched to a maximum waiting time within the traffic light cycle, and ‘Jₘₐₓ’ denotes the time point for the probe vehicle to reach the crossroad, which is matched to the minimum signal waiting time within the traffic light cycle, when the signal of the traffic light is not the progress signal at the time point for the probe vehicle to enter the crossroad, and the time point for the probe vehicle to enter the crossroad is earlier than the correction reference.

The processor corrects the traveling speed of the probe vehicle by reflecting the correction value.

The processor additionally corrects a signal waiting time by reflecting a traffic congestion degree.

According to another embodiment of the present disclosure, a method for providing traffic information includes receiving crossroad passing information and traffic light information from a probe vehicle, selecting a correction reference based on the traffic light information, correcting a traveling speed of the probe vehicle based on the correction reference, and providing the traffic information by reflecting the corrected traveling speed.

The crossroad passing information includes a time to pass through a crossroad.

The traffic light information includes a traffic light cycle, a signal state, and a time remaining until a signal is changed.

The selecting of the correction reference includes selecting, as the correction reference, a time point for the probe vehicle to reach a crossroad, which is matched to an average signal waiting time at the crossroad through which the probe vehicle passes.

The correcting of the traveling speed of the probe vehicle includes calculating a correction value for correcting a time for the probe vehicle to pass through the crossroad by utilizing the correction reference, the traffic light information, and the time point for the probe vehicle to reach the crossroad.

The correcting of the traveling speed of the probe vehicle includes determining, as the correction value, the average signal waiting time at the crossroad, when a signal of a traffic light is a progress signal at a time point for the probe vehicle to enter the crossroad.

The correcting of the traveling speed of the probe vehicle includes calculating the correction value (C) through

$$C ( {J}_{i} > J ) = \frac{- T}{{J}_{max} - J} ( {J}_{i} - J ) + T ,$$

in which ‘T’ denotes the average signal waiting time, ‘J’ denotes the correction reference, ‘J₁’ denotes the time point for the probe vehicle to enter the crossroad, Jₘₐₓ denotes a time point for the probe vehicle to reach the crossroad, which is matched to a minimum signal waiting time within a traffic light cycle, when a signal of a traffic light is not a progress signal at a time point for the probe vehicle to enter the crossroad, and the probe vehicle enters the crossroad later than the correction reference.

The correcting of the traveling speed of the probe vehicle includes calculating the correction value (C) through

$$C ( {J}_{i} < J ) = \frac{{T}_{max} - T}{J - {J}_{min}} ( {J}_{i} - {J}_{min} ) + ( T - {T}_{max} ) ,$$

in which ‘T’ denotes the average signal waiting time, ‘Tₘₐₓ’ denotes a maximum waiting time, ‘J’ denotes the correction reference, ‘Jᵢ’ denotes the time point for the probe vehicle to enter the crossroad, ‘Jₘᵢₙ’ denotes a time point for the probe vehicle to reach the crossroad, which is matched to a maximum waiting time within the traffic light cycle, and ‘Jₘₐₓ’ denotes a time point for the probe vehicle to reach the crossroad, which is matched to the minimum signal waiting time within the traffic light cycle, when a signal of a traffic light is not a progress signal at a time point for the probe vehicle to enter the crossroad, and the time point for the probe vehicle to enter the crossroad is earlier than the correction reference.

The correcting of the traveling speed of the probe vehicle includes correcting the traveling speed of the probe vehicle by reflecting the correction value.

The correcting of the traveling speed of the probe vehicle further includes additionally correcting a signal waiting time by reflecting a traffic congestion degree.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a view illustrating a system for providing traffic information, according to an embodiment of the present disclosure;

FIG. 2 is a block diagram illustrating a probe vehicle illustrated in FIG. 1;

FIG. 3 is a block diagram illustrating a server illustrated in FIG. 1;

FIG. 4 is a view illustrating the setting of a correction reference in relation to embodiments of the present disclosure;

FIG. 5 is a view illustrating the calculation of a correction value for a crossroad passing time, in relation to embodiments of the present disclosure;

FIG. 6 is a view illustrating the correction of a signal waiting time in relation to embodiments of the present disclosure;

FIG. 7 is a view illustrating a method for providing traffic information, according to an embodiment of the present disclosure; and

FIG. 8 illustrates a case of employing the technology of providing traffic information, according to an embodiment of the present disclosure.

### DETAILED DESCRIPTION OF ILLUSTRATIVE EMBODIMENTS

Hereinafter, some embodiments of the present disclosure will be described in detail with reference to accompanying drawings. In adding the reference numerals to the components of each drawing, it should be noted that the identical or equivalent component is designated by the identical numeral even when they are displayed on other drawings. In addition, in the following description of an embodiment of the present disclosure, a detailed description of well-known features or functions will be ruled out in order not to unnecessarily obscure the gist of the present disclosure

In describing the components of the embodiments according to the present disclosure, terms such as first, second, “A”, “B”, (a), (b), and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

In the embodiments of the present disclosure, a link refers to a line of connecting a node with a node, and is formed at a point such as a road, a bridge, an overpass, an underpass and/or a tunnel. In this case, the node refers to a point, such as a crossroad, a bridge start point, an overpass start point, a start point of a road, an underpass start point, a tunnel start point, an administration border, an interchange and/or a junction (JC), at which the variation of the speed is made when a vehicle travels on a road. The link may be used as a meaning of, for example, a road section, and may be formed for each direction of a traffic flow.

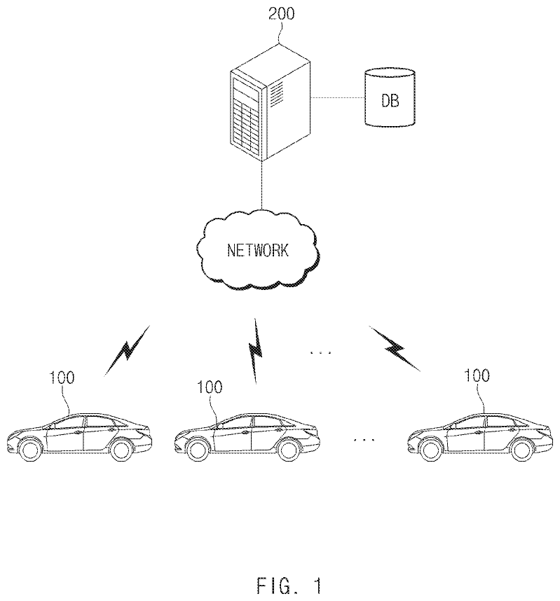

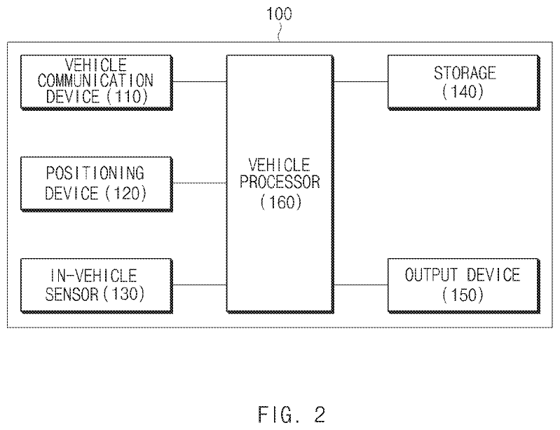

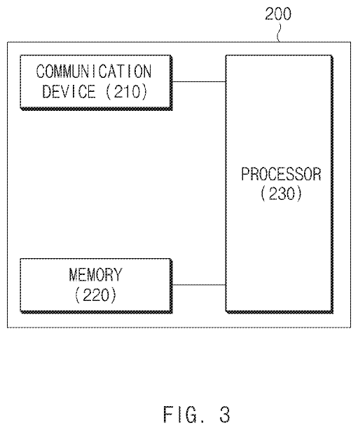

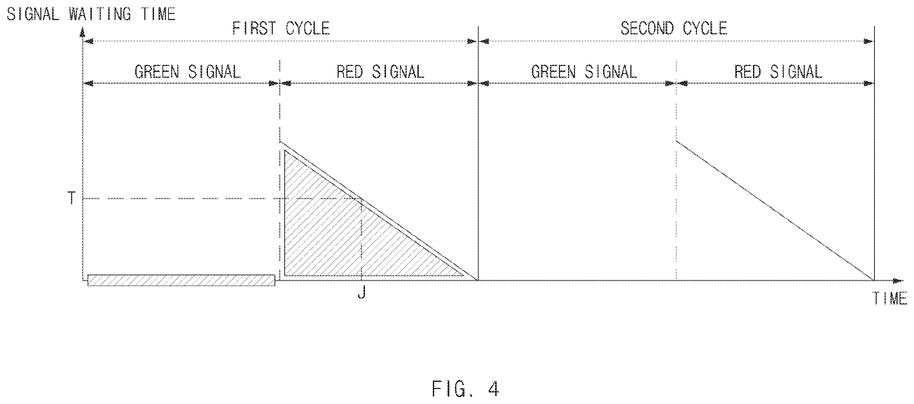

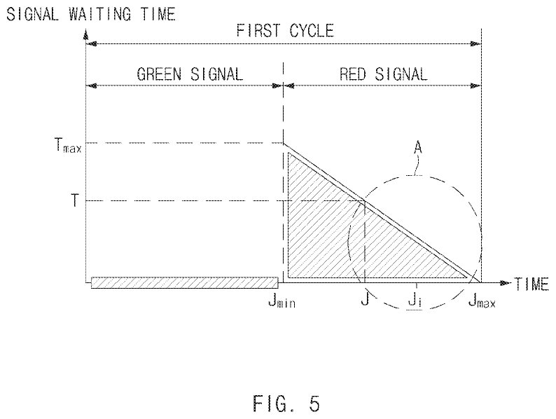

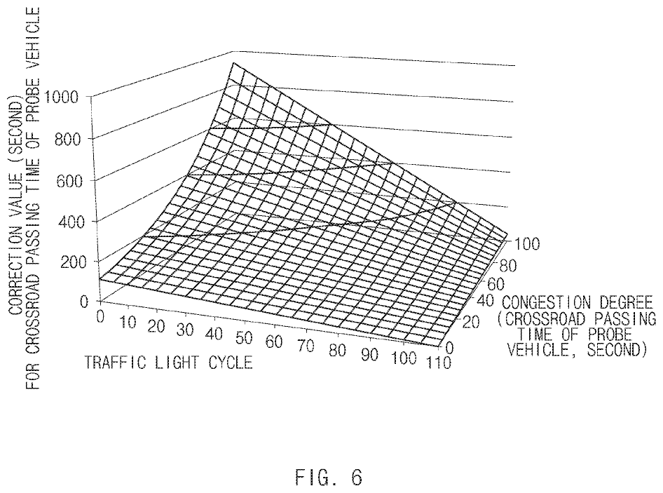

FIG. 1 is a view illustrating a system (traffic information service system) for providing traffic information, according to an embodiment of the present disclosure, FIG. 2 is a block diagram illustrating a probe vehicle wo illustrated in FIG. 1, FIG. 3 is a block diagram illustrating a server 200 illustrated in FIG. 1, FIG. 4 is a view illustrating the setting of a correction reference in relation to embodiments of the present disclosure, FIG. 5 is a view illustrating the calculation of a correction value for a crossroad passing time, in relation to embodiments of the present disclosure, and FIG. 6 is a view illustrating the correction of a signal waiting time in relation to embodiments of the present disclosure.

Referring to FIG. 1, a traffic information service system includes a probe vehicle 100 and a server 200 which exchange data together through a network. The network may be implemented with a wireless Internet network, a local area network and/or a mobile communication network. The wireless Internet network may be implemented with a wireless local area network (WLAN) and/or a wireless broadband (Wibro). The local area network may be implemented with Bluetooth, Near Field Communication (NFC), Radio Frequency Identification (RFID), and/or ZigBee. The mobile communication network may be implemented with Code Division Multiple Access (CDMA), Global System for Mobile communication (GSM), Long Term Evolution (LTE), and/or International Mobile Telecommunication (IMT)-2020.

The probe vehicle 100 may travel on a road while collecting probe data (traffic information) such as a vehicle position, vehicle state information, and/or road information, and may transmit the probe data to the server 200. As illustrated in FIG. 2, the probe vehicle 100 includes a vehicle communication device no, a positioning device 120, an in-vehicle sensor 130, a storage 140, an output device 150, and a vehicle processor 160.

The vehicle communication device no communicates with the server 200. The vehicle communication device no may use a communication technology such as wireless internet, near field communication, and/or mobile communication. The vehicle communication device no may perform wireless communication with other vehicles and/or another vehicle 100 using a vehicle to everything (V2X) technology. The V2X technologies include Vehicle to Vehicle (V2V), Vehicle to Infrastructure (V2I), and/or Vehicle-to-Nomadic Devices (V2N).

The positioning device 120 measures a present position of the probe vehicle, that is, a probe vehicle position (hereinafter referred to as a vehicle position). The positioning device 120 may measure the vehicle position using at least one of positioning technologies such as Global Positioning System (GPS), Dead Reckoning (DR), Differential GPS (DGPS), and/or Carrier phase Differential GPS (CDGPS).

The in-vehicle sensor 130 may be mounted inside the vehicle to obtain vehicle state information, road information, and/or surrounding situation information. The in-vehicle sensor 130 may include a vehicle velocity sensor (vehicle speed sensor), an odometer, a steering angle sensor, an image sensor, a Radio Detecting And Ranging (radar), a Light Detection And Ranging (LiDAR), and/or an ultrasonic sensor.

The in-vehicle sensor 130 may store the sensed data in the storage 140 and may transmit the sensed data to the vehicle processor 160. For example, the in-vehicle sensor 130 may obtain vehicle state information such as a vehicle speed and/or a driving distance, may store the vehicle state information in the storage 140, and may transmit the vehicle state information to the vehicle processor 160.

The storage 140 may store software programmed for the vehicle processor 160 to perform a specific operation. The storage 140 may store navigation software and map data. The storage 140 may store sensing data obtained by the in-vehicle sensor 130. In addition, the storage 140 may store traffic light information received through the vehicle communication device no. The storage 140 may be implemented with at least one storage medium (recording medium) of storage media (recording media) such as a flash memory, a hard disk, a Security Digital (SD) card, a Random Access Memory, a Read Only Memory (ROM), an Electrically Erasable and Programmable ROM (EEPROM), an Erasable and Programmable ROM (EPROM), and/or a register.

The output device 150 may output various types of information in the form of visual information, audible information, and/or tactile information. The output device 150 may output the progressing situation and the result from the operation of the vehicle processor 160. The output device 150 may include a display, an audio output device, and/or a haptic device. The display may include at least one of a liquid crystal display (LCD), a thin film transistor-liquid crystal display (TFT LCD), an organic light-emitting diode (OLED) display, a flexible display, a 3D display, a transparent display, a head-up display (HUD), a touch screen, and a cluster. A sound output device, which reproduces and outputs audio data stored in the storage 140, may be implemented with a speaker. The haptic device outputs a tactile signal (e.g., vibration) that may be perceived by the user by controlling the vibration intensity and the vibration pattern of a vibrator. In addition, the display may be implemented with a touch screen combined with a touch sensor, and may be used as an input device as well as an output device.

The vehicle processor 160 performs a specific function and/or operation in the probe vehicle wo. The vehicle processor 160 may include at least one of an application specific integrated circuit (ASIC), a digital signal processor (DSP), a programmable logic device (PLD), a field programmable gate array (FPGA), a central processing unit (CPU), a microcontroller, and/or a microcomputer.

The vehicle processor 160 may obtain a vehicle position through the positioning device 120 and may map the obtained vehicle position to map data to determine the entrance to the crossroad or the exit from the crossroad. The vehicle processor 160 obtains crossroad passing information and traffic light information, when the vehicle passes through the crossroad. The crossroad passing information may include information on an identification of a crossroad, a time point (a time point to reach the crossroad) to enter the crossroad, and a time (crossroad passing time) for the probe vehicle to pass through the crossroad. In this case, the crossroad passing time is a time taken for the probe vehicle wo to pass through the crossroad. The traffic light information includes a traffic light cycle, a signal state (for example, a green signal, a red signal, or a yellow signal), and a time remaining until a signal is changed (that is, a time remaining until a present signal is changed), when the vehicle passes through the crossroad. The vehicle processor 160 may receive the traffic light information from a traffic light controller and/or a traffic signal management center installed at a roadside, through the vehicle communication device 110.

The vehicle processor 160 generates probe data by using the crossroad passing information and the traffic light information obtained at a time point at which the vehicle passes through the crossroad. The vehicle processor 160 transfers (transmits) the generated probe data to the server 200 through the vehicle communication device 110.

The server 200 collects probe data received from at least one probe vehicle 100. The server 200 generates real-time traffic information based on the previously collected probe data. The server 200 may transmit the generated real-time traffic information to one or more different vehicles. The server 200 may include a communication device 210, a memory 220, and a processor 230 as illustrated in FIG. 3.

The communication device 210 may communicate with the probe vehicle 100 and/or different vehicles. The communication device 210 may use a communication technology such as a wireless Internet technology, a near field communication technology, and/or a mobile communication technology. A wired internet technology may include Local Area Network (LAN), Wide Area Network (WAN), Ethernet and/or Integrated Services Digital Network (ISDN).

The memory 220 may store a program for the operation of the processor 230 and may store preset setting information. The memory 220 may store an algorithm of generating pattern traffic information. The memory 220 may be implemented with at least one storage medium (recording medium) of storage media (recording media) such as a flash memory, a hard disk, a Security Digital (SD) card, a Random Access Memory, a Static Random Access Memory (SRAM), a Read Only Memory (ROM), a Programmable Read Only Memory (PROM), an Electrically Erasable and Programmable ROM (EEPROM), an Erasable and Programmable ROM (EPROM), and/or a register.

The processor 230 controls the overall operation of the server 200. The processor 230 may include at least one of an Application Specific Integrated Circuit (ASIC), a Digital Signal Processor (DSP), Programmable Logic Devices (PLD), Field Programmable Gate Arrays (FPGAs), a Central Processing Unit (CPU), microcontrollers, and/or microprocessors.

The processor 230 receives probe data received from the probe vehicle wo through the communication device 210. The processor 230 corrects the crossroad passing time by using the traffic light information included in the probe data, and generates real-time traffic information by using the corrected crossroad passing time and a link length.

In more detail, the processor 230 selects a correction reference for correcting the crossroad passage time. The processor 230 calculates the total signal waiting time for one cycle of the traffic light cycles. In this case, the total signal waiting time refers to the sum of signal waiting times for each time point at which the probe vehicle wo enters a crossroad. The processor 230 calculates an average signal waiting time in units of one second. The processor 230 calculates a time point for the probe vehicle wo to reach the crossroad, which corresponds to the average signal waiting time. For example, when the traffic light cycle of the crossroad where the probe vehicle wo has passed is as illustrated in FIG. 4, the processor 230 calculates the total signal waiting time for the one cycle of the corresponding traffic light and calculates the average signal waiting time ‘T’ based on the calculated total signal waiting time. The processor 230 calculates a time point ‘J’ for the probe vehicle wo to reach the crossroad, which is matched to the average signal waiting time.

The processor 230 selects the calculated time point ‘J’ for the probe vehicle wo to reach the crossroad, as a correction reference. In other words, the processor 230 selects the time point ‘J’ for the probe vehicle wo to reach the crossroad as the correction reference, based on the average signal waiting time depending on the time point at which the probe vehicle 100 passes through the crossroad.

The processor 230 calculates a correction value (a crossroad passing time correction value) for correcting the crossroad passing time of the probe vehicle 100 by utilizing the correction reference J, the traffic light information, and a time point Jᵢ at which the probe vehicle 100 reaches the crossroad. The processor 230 determines whether a time point Jᵢ for the probe vehicle 100 to reach the crossroad exceeds the correction reference J, when a signal of the traffic light information is not the progress signal (that is, the green signal) at the time point Jᵢ for the probe vehicle 100 to reach the crossroad. The processor 230 calculates a correction value C(Ji>J) through the following Equation 1, when the time point Jᵢ for the probe vehicle 100 to reach the crossroad exceeds the correction reference J.

$$C ( {J}_{i} > J ) = \frac{- T}{{J}_{max} - J} ( {J}_{i} - J ) + T \qquad Equation 1$$

In this case, Jₘₐₓ denotes a time point for the probe vehicle 100 to reach the crossroad, which is matched to the minimum signal waiting time within the traffic light cycle.

The processor 230 calculates the correction value C(Jᵢ<J) through the following Equation 2 when the time point Jᵢ for the probe vehicle 100 to reach the crossroad is earlier than the correction reference J.

$$C ( {J}_{i} < J ) = \frac{{T}_{max} - T}{J - {J}_{min}} ( {J}_{i} - {J}_{min} ) + ( T - {T}_{max} ) \qquad Equation 2$$

In this case, Jₘᵢₙ denotes a time point for the probe vehicle 100 to reach the crossroad, which is matched to the maximum waiting time within the traffic light cycle, and Tₘₐₓ is the maximum signal waiting time.

The processor 230 determines the correction value C as the average signal waiting time T, when the traffic light information does not indicate the progress signal (that is, the green signal) at the time point Jᵢ for the probe vehicle 100 to reach the crossroad.

For example, the processor 230 calculates the correction value C using Equation 1, when at the time point Jᵢ for the probe vehicle 100 to reach the crossroad exceeds the correction reference J as illustrated in FIG. 5.

The processor 230 corrects the traveling speed of the probe vehicle 100 by using the calculated correction value C. In other words, the processor 230 corrects the vehicle speed on the section (e.g., the crossroad), that is, the link where the probe vehicle 100 travels, using the calculated correction value C. The vehicle speed (link traveling speed, or a crossroad passing speed) V on the link may be expressed as in Equation 3.

$$V = \frac{L}{{T}_{travel} + C} \qquad Equation 3$$

In this case, L denotes a link length, and Tₜᵣₐᵥₑₗ denotes a link traveling time.

The processor 230 generates traffic information using the corrected traveling speed of the probe vehicle 100 and provides the traffic information to a different vehicle.

The processor 230 may tune the traffic light correction value (signal waiting time correction value) through a regression analysis among an actual time when the probe vehicle 100 passed, a traffic congestion degree (crossroad passing time), a time point for the probe vehicle 100 to enter the crossroad, and a traffic light cycle (change cycle of a traffic light). In other words, the processor 230 additionally corrects the signal waiting time by reflecting the traffic congestion degree. For example, the processor 230 may tune the traffic light correction value for a section A of FIG. 5, as illustrated in FIG. 6.

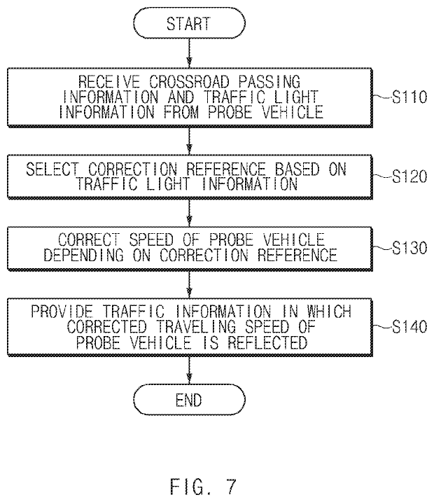

FIG. 7 is a view illustrating a method for providing traffic information, according to an embodiment of the present disclosure.

Referring to FIG. 7, the server 200 receives crossroad passing information and traffic light information from the probe vehicle 100 (S110). When the probe vehicle 100 passes through the crossroad, the probe vehicle 100 obtains the crossroad passing information and the traffic light information and transmits the crossroad passing information and the traffic light information to the server 200. The crossroad passing information may include information on an identification of a crossroad, a time point to enter the crossroad, and a time to pass the crossroad, and the traffic light information includes information on an identification of a traffic light, a traffic light cycle, a signal state, and a time remaining until a signal is changed.

The server 200 selects a correction reference based on the traffic light information (S120). The server 200 determines the correction reference based on the average signal waiting time at the crossroad through which the probe vehicle 100 passes. The server 200 determines the time point to reach the crossroad (the time point to enter the crossroad), which is matched to the average signal waiting time.

The server 200 corrects the traveling speed of the probe vehicle 100 depending on the correction reference (S130). The server 200 calculates the correction value (a crossroad passing time correction value) for correcting the crossroad passing time of the probe vehicle 100 by utilizing the correction reference J, traffic light information, and a time point Jᵢ for the probe vehicle 100 to reach the crossroad. The server 200 determines the average signal waiting time T at the crossroad as the correction value, when the probe vehicle 100 enters (reaches) the crossroad, in the state that the traffic light at the crossroad indicates a progress signal. The server 200 calculates the correction value C using Equation 1 when the probe vehicle 100 reaches the crossroad later than the correction reference J in the state that the signal of the traffic light at the crossroad is not the progress signal. Meanwhile, the server 200 calculates the correction value C using Equation 2 when the probe vehicle 100 reaches the crossroad earlier than the correction reference J in the state that the signal of the traffic light at the crossroad is not the progress signal. The server 200 corrects the traveling speed of the probe vehicle 100 by reflecting the calculated correction value C. In other words, the server 200 corrects the traveling speed of the probe vehicle 100 using Equation 3.

The server 200 provides traffic information in which the corrected traveling speed of the probe vehicle 100 is reflected (S140). The server 200 generates traffic information by employing the corrected traveling speed of the probe vehicle 100 as the crossroad passing speed, and provides the generated traffic information to another vehicle that is scheduled to pass through the crossroad.

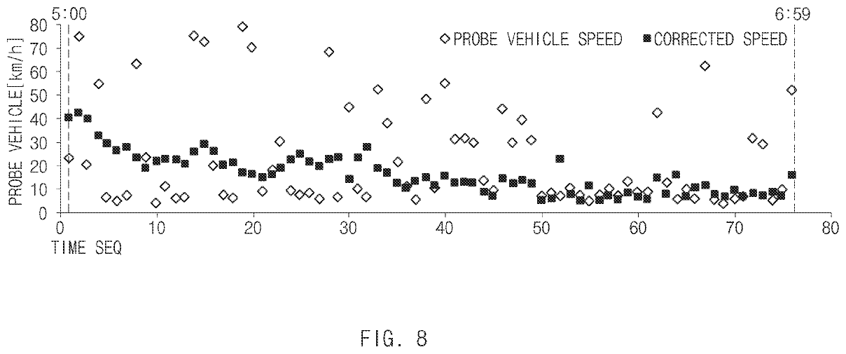

FIG. 8 illustrates a case of employing the technology of providing traffic information, according to an embodiment of the present disclosure.

Referring to FIG. 8, it may be recognized that information of a probe vehicle traveling at a high speed at dawn or caught in a traffic light is significantly corrected. Accordingly, it may be recognized that the precision of displaying the traffic information is improved.

As described above, according to embodiments of the present disclosure, the precision of the traffic information may be improved by displaying the real-time traffic information as the speed distribution of the probe vehicle 100 to be matched a traffic flow. In addition, the logic of searching for a route may be enhanced by clearly distinguishing between link cost (traffic information) and node cost (traffic light correction value) in searching for the route.

According to embodiments of the present disclosure, the representative traffic information may be generated only through one probe vehicle by reflecting information on the traffic signal when generating the traffic information.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A system for providing traffic information, the system comprising:
a communication device configured to receive crossroad passing information and traffic light information from a probe vehicle; and
a processor configured to select a correction reference based on the traffic light information, correct a traveling speed of the probe vehicle based on the correction reference, and provide the traffic information by reflecting the corrected traveling speed.

2. The system of claim 1, wherein the crossroad passing information includes a time for the probe vehicle to pass through a crossroad.

3. The system of claim 1, wherein the traffic light information includes a traffic light cycle, a signal state, and a time remaining until a signal is changed.

4. The system of claim 1, wherein the processor is configured to select, as the correction reference, a time point for the probe vehicle to reach a crossroad, which is matched to an average signal waiting time at the crossroad through which the probe vehicle passes.

5. The system of claim 4, wherein the processor is configured to calculate a correction value for correcting a time for the probe vehicle to pass through the crossroad by utilizing the correction reference, the traffic light information, and the time for the probe vehicle to reach the crossroad.

6. The system of claim 5, wherein the processor is configured to determine, as the correction value, the average signal waiting time at the crossroad, when a signal of a traffic light is a progress signal at a time point for the probe vehicle to enter the crossroad.

7. The system of claim 6, wherein the processor is configured to calculate the correction value (C) through Equation 1, when the signal of the traffic light is not the progress signal at the time point for the probe vehicle to enter the crossroad, and when the probe vehicle enters the crossroad later than the correction reference, wherein the Equation 1 is
$$C ( {J}_{i} > J ) = \frac{- T}{{J}_{max} - J} ( {J}_{i} - J ) + T$$
in which ‘T’ denotes the average signal waiting time, ‘J’ denotes the correction reference, ‘Jᵢ’ denotes the time point for the probe vehicle to enter the crossroad, and Jₘₐₓ denotes a time point for the probe vehicle to reach the crossroad, which is matched to a minimum signal waiting time within a traffic light cycle.

8. The system of claim 7, wherein the processor is configured to calculate the correction value (C) through Equation 2, when the signal of the traffic light is not the progress signal at the time point for the probe vehicle to enter the crossroad, and when the time point for the probe vehicle to enter the crossroad is earlier than the correction reference, wherein the Equation 2 is
$$C ( {J}_{i} < J ) = \frac{{T}_{max} - T}{J - {J}_{min}} ( {J}_{i} - {J}_{min} ) + ( T - {T}_{max} )$$
in which ‘T’ denotes the average signal waiting time, ‘Tₘₐₓ’ denotes a maximum waiting time, ‘J’ denotes the correction reference, ‘Jᵢ’ denotes the time point for the probe vehicle to enter the crossroad, denotes the time point for the probe vehicle to reach the crossroad, which is matched to a maximum waiting time within the traffic light cycle, and ‘Jₘₐₓ’ denotes the time point for the probe vehicle to reach the crossroad, which is matched to the minimum signal waiting time within the traffic light cycle.

9. The system of claim 8, wherein the processor is configured to correct the traveling speed of the probe vehicle by reflecting the correction value.

10. The system of claim 1, wherein the processor is configured to additionally correct a signal waiting time by reflecting a traffic congestion degree.

11. A method for providing traffic information, the method comprising:
receiving crossroad passing information and traffic light information from a probe vehicle;
selecting a correction reference based on the traffic light information;
correcting a traveling speed of the probe vehicle based on the correction reference; and
providing the traffic information by reflecting the corrected traveling speed.

12. The method of claim 11, wherein the crossroad passing information includes a time to pass through a crossroad.

13. The method of claim 11, wherein the traffic light information includes a traffic light cycle, a signal state, and a time remaining until a signal is changed.

14. The method of claim 11, wherein selecting the correction reference includes selecting, as the correction reference, a time point for the probe vehicle to reach a crossroad, which is matched to an average signal waiting time at the crossroad through which the probe vehicle passes.

15. The method of claim 14, wherein correcting the traveling speed of the probe vehicle includes calculating a correction value for correcting a time for the probe vehicle to pass through the crossroad by utilizing the correction reference, the traffic light information, and the time point for the probe vehicle to reach the crossroad.

16. The method of claim 15, wherein correcting the traveling speed of the probe vehicle includes determining, as the correction value, the average signal waiting time at the crossroad, when a signal of a traffic light is a progress signal at a time point for the probe vehicle to enter the crossroad.

17. The method of claim 16, wherein correcting the traveling speed of the probe vehicle includes correcting the traveling speed of the probe vehicle by reflecting the correction value.

18. The method of claim 15, wherein correcting the traveling speed of the probe vehicle includes calculating the correction value (C) through Equation 1, when a signal of a traffic light is not a progress signal at a time point for the probe vehicle to enter the crossroad, and when the probe vehicle enters the crossroad later than the correction reference, wherein the Equation 1 is
$$C ( {J}_{i} > J ) = \frac{- T}{{J}_{max} - J} ( {J}_{i} - J ) + T$$
in which ‘T’ denotes the average signal waiting time, ‘J’ denotes the correction reference, ‘Jᵢ’ denotes the time point for the probe vehicle to enter the crossroad, and Jₘₐₓ denotes a time point for the probe vehicle to reach the crossroad, which is matched to a minimum signal waiting time within a traffic light cycle.

19. The method of claim 15, wherein correcting the traveling speed of the probe vehicle includes calculating the correction value (C) through Equation 2, when a signal of a traffic light is not a progress signal at a time point for the probe vehicle to enter the crossroad, and when the time point for the probe vehicle to enter the crossroad is earlier than the correction reference, wherein the Equation 2 is
$$C ( {J}_{i} < J ) = \frac{{T}_{max} - T}{J - {J}_{min}} ( {J}_{i} - {J}_{min} ) + ( T - {T}_{max} )$$
in which ‘T’ denotes the average signal waiting time, ‘Tₘₐₓ’ denotes a maximum waiting time, ‘J’ denotes the correction reference, ‘Jᵢ’ denotes the time point for the probe vehicle to enter the crossroad, ‘Jₘᵢₙ’ denotes a time point for the probe vehicle to reach the crossroad, which is matched to a maximum waiting time within a traffic light cycle, and ‘Jₘₐₓ’ denotes a time point for the probe vehicle to reach the crossroad, which is matched to a minimum signal waiting time within the traffic light cycle.

20. The method of claim 11, wherein correcting the traveling speed of the probe vehicle further includes additionally correcting a signal waiting time by reflecting a traffic congestion degree.
